(19) United States
(12) Patent Application Publication
(10) Pub. No.: US 2004/0047622 A1
(43) Pub. Date: Mar. 11, 2004

(54) Filter mechanism for a camera

(76) Inventor: Barry Holmes, Manchester (GB)

Correspondence Address: NOTARO AND MICHALOS, 100 DUTCH HILL ROAD, SUITE 110, ORANGEBURG, NY, 10962-2100, US

(21) Appl. No.: 10/658,061

(22) Filed: Sep. 9, 2003

(30) Foreign Application Priority Data
Sep. 9, 2002 (GB) 0220787.6

(51) Int. Cl. G03B 19/12

(52) U.S. Cl. 396/355

(57) ABSTRACT

A filter mechanism (10) for a camera comprises two filter elements (12) angularly spaced on a moveable paddle (14). The paddle is rotated by a drive arrangement (13) which allows either filter element (12) to be brought into position within the focus mechanism of the camera.

This invention relates to an improved filter mechanism for a camera and in particular, but not exclusively, for a closed circuit television (CCTV) camera.

CCTV cameras are used extensively in security and surveillance systems and such systems are usually required to operate in both daylight and night conditions. Therefore, in order to control the amount of light reaching the imaging element of the camera to ensure optimum performance, it is usual to utilise a filter mechanism which during daylight hours filters out some of the light incident on the imaging element of the camera to avoid saturation of the image and during night conditions, to maximise the amount of light which is incident on the imaging element to ensure that an Image of sufficient intensity is produced.

Hitherto, where such filter mechanisms are used, they have been arranged such that the required filters can be moved along a longitudinal guide into and out of a position where they cover the imaging element of the camera. If a number of filters are used for different light conditions, it will be appreciated that using a longitudinal guide will introduce minimum dimensions to that part of the camera in which the filter mechanism is to be mounted. This minimum dimension requirement can be unwanted from a design point of view and severely limits the ability to produce more discrete cameras.

The present invention seeks to provide a camera in which a comparable day and night performance can be achieved as in the prior art arrangements but without the dimensional limitations of known filter mechanisms.

Thus and in accordance with the present invention there is provided a filter mechanism for a camera comprising at least one filter element, said elements being moveable into and out of a position whereby it covers an imaging element of said camera, said movement being by pivoting.

With this arrangement, the pivoting movement of the filter element into and out of position enables the dimensions of the camera to be kept as small as possible.

Preferably at least two filter elements are provided and in this case, the elements are mounted on the paddle which is pivotably mounted at one end thereof.

Preferably the at least two filter elements are mounted in angular spaced positions on said paddle relative to said.

Preferably a switching arrangement is provided to cause pivoting of said filter and switching arrangement comprises a drive mechanism which when actuated causes said paddle to pivot about said pivot. Most preferably said drive mechanism comprises a solenoid pivotably connected to the pivot whereby actuation of the solenoid causes rotation of the pivot thereby pivoting said paddle.

Most preferably said switching arrangement also includes a biasing means and said pivot is rotated against the bias of the biasing means whereby when said driving mechanism is de-actuated, said paddle returns to its initial position under the action of the biasing means. Preferably the biasing means comprises a return spring.

The invention will now be described further by way of example only and with reference to the accompanying drawings in which:—

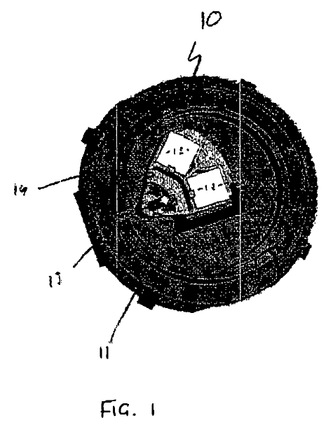

FIG. 1 shows a schematic view of a part of a CCTV camera including a filter mechanism according to one embodiment of the present invention in a first position,

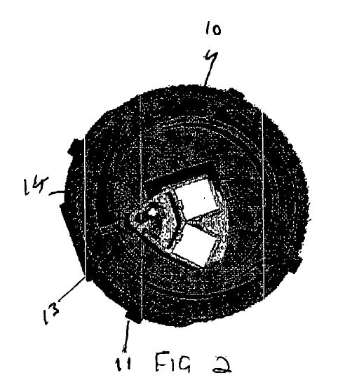

FIG. 2 shows the arrangement of FIG. 1 in a second position; and

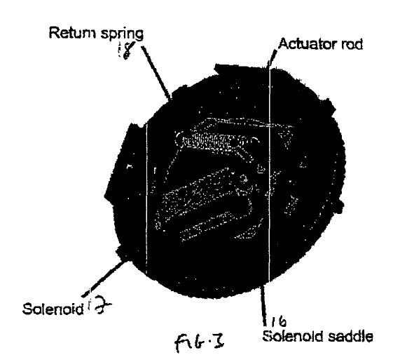

FIG. 3 shows a schematic rear view of the arrangement of FIGS. 1 and 2.

Referring now to the figures, there is shown in FIGS. 1 and 2 one embodiment of the filter mechanism 10 in accordance with the present invention.

The filter mechanism 10 comprises a paddle 14 upon which two filter elements 12 are disposed in angularly spaced disposition relative to an actuator 13. The actuator 13 is fixedly connected to a paddle 14 in such a way that rotation of the actuator 13 causes pivotal movement of the paddle 14 about the actuator 13.

The actuator 13 is further fixedly connected to a pivot connector 16 which is, in turn, pivotably connected to one end of the drive means 17 in the form of a solenoid. Whilst it is preferred that the drive means 17 comprises a solenoid, it will be appreciated that the drive means 17 can comprise any suitable drive as desired or as appropriate.

Another end of the pivot connector 16 is connected to a biasing means 18, preferably in the form of a return spring.

In use, the filter mechanism of the present invention can be conveniently incorporated into the focus mechanism of the day and night CCTV camera. The only restriction on where the mechanism can be provided is that the filter elements 12 must be capable of covering, preferably completely, the imaging element (not shown) of the camera.

The filter elements 12 chosen will depend on the application to which the camera will be put, but for use in a day or night camera, filters which filter out infrared wavelengths from the incident light are commonly used. Thus during daylight hours, a filter element 12 which filters out infrared wavelengths will be moved so as to cover the imaging element and during night hours, a filter which filters out light at other wavelengths from the incident light than infrared wavelengths is moved Into this position.

The movement of the respective filter elements into and out of position occurs as follows:—

In FIG. 1, the arrangement is shown in which a first filter 12 is positioned covering the imaging element. Say for example this is the position during day time operation, when night time is detected in any suitable manner, the paddle can then be moved to a position in which the other filter element 12 covers the imaging element. This is achieved by supplying an electrical signal to the solenoid 17 which in turn causes rotation of the pivot connector 16, and the actuator 13 against the bias of the return spring 18.

Rotation of the actuator 13 will cause the paddle 11 to pivot about the actuator 13 until the other filter element 12 is in a position covering the imaging element. The filter 12 is held In position by the solenoid 17 until daylight is detected. At this time, the electrical signal to the solenoid is removed and the paddle 11 returns to the position shown in FIG. 1, where the first filter element covers the imaging element 12, under the bias of the return spring 18.

Day and night can be determined in any suitable manner and may be detected by the imaging element itself by detection of light and intensity or alternatively, detection can take place in any suitable manner using a separate sensor.

The movement of the filter 12 may be effected under microprocessor control and in these circumstances, a suitably preferred microprocessor may be linked to the imaging element and external light sensor and control operation of the filters accordingly.

With this arrangement it is possible to provide a filter mechanism which is of high performance but which can occupy only a small part of the camera thereby placing no limitation on the dimension of the camera.

It is of course to be understood that the invention is not intended to be restricted to the details of the above embodiments which are described by way of example only.

1. A filter mechanism for a camera comprising at least one filter element, said at least one element being moveable into and out of a position whereby it covers an imaging element of the camera, said movement being by pivoting.

2. A filter mechanism according to claim 1, wherein at least two filter elements are provided, each said element being mounted on a paddle which is pivotally mounted at one end thereof.

3. A filter mechanism according to claim 1 wherein the at least two filter elements are mounted in angularly spaced positions on the said paddle relative to said pivot.

4. A filter mechanism according to claim 1 wherein a switching arrangement is provided to cause pivoting of said filter elements.

5. A filter mechanism according to claim 4, wherein said switching arrangement comprises a drive mechanism which when actuated causes the said paddle to pivot about said pivot.

6. A filter mechanism according to claim 5, wherein the drive mechanism comprises a solenoid pivotably connected to the pivot whereby actuation of a solenoid causes rotation of the pivot thereby pivoting said paddle.

7. A filter mechanism according to claim 4 wherein the switching arrangement includes a biasing means and said pivot is rotated against the bias of the biasing means whereby, when the driving mechanism is de-actuated, said paddle returns to its initial position under the action of the biasing means.

8. A filter mechanism according to claim 7 in which said biasing means comprises a return spring.
